(19) United States
(12) Patent Application Publication
(10) Pub. No.: US 2011/0051434 A1
(43) Pub. Date: Mar. 3, 2011

(54) Decorative Lamp

(76) Inventor: Chien-Feng Lin, Jhonghe City (TW)

(21) Appl. No.: 12/550,779

(22) Filed: Aug. 31, 2009

(51) Int. Cl. F21V 21/08; F21V 19/00; F21S 8/00

(52) U.S. Cl. 362/396; 362/382; 362/427

(57) ABSTRACT

The present invention disclosed a decorative lamp including a top base, a cover, a connecting device and an adjusting element. The connecting device is connected to a lamp base by a fixing ring element, and the lamp base can be moved pivotally, and the adjusting element is adjusted up and down to drive the fixing ring element to control the lamp base to be spread open, so as to achieve the effects of controlling a projection angle of the lamp source and improving an overall vivid variation.

### BACKGROUND OF THE INVENTION

(a) Field of the Invention

The present invention relates to a lamp, in particular to a decorative lamp with the function of spreading open and closing a lamp base to control the projection angle of a light source of the lamp.

(b) Description of the Related Art

In general, a lamp plays an important role indispensable to our life. As our society becomes more prosperously in commercial and industrial areas, our living standard becomes increasingly higher, and people play more attention to their living quality and personal taste and want to have a nice and comfortable environment for taking rest and relieving pressure after work. Therefore, consumers would like to decorate their home appropriately regardless of a new house or an old house, and a decorative lamp or a hanging lamp is one of the best choices since it comes with diversified styles, not only providing illuminations, but also decorating the interior of a house to give an overall aesthetic visual effect.

However, a conventional decorative lamp is mainly used for decoration, and thus the angle and position of the illumination are fixed, and the light for the illumination cannot be adjusted, and it is difficult to achieve the diversified aesthetic visual effects as well as the power-saving and environmental protection requirements Obviously, the conventional decorative lamp requires further improvements to achieve the aforementioned effects.

### SUMMARY OF THE INVENTION

It is a primary objective of the present invention to provide a decorative lamp comprising a top base with a joint as an end of the top base and a connecting end as another end of the top base, wherein the connecting end is a connecting rod connected to a cover, and the cover includes a plurality of first slots disposed at an external periphery of the cover, and the cover is installed onto a supporting decorative base, and a connecting device is installed between the cover and the supporting decorative base and composed of a fixing ring element and a plurality of lamp bases, and an adjusting element is passed through and installed to the supporting decorative base for fixing the fixing ring element simultaneously. The present invention is characterized in that the connecting device is connected to a lamp base by a fixing ring element, and the lamp base can be moved pivotally, and the adjusting element is provided for making up-and-down adjustment to drive the fixing ring element to control the lamp base to be spread open and closed, so as to achieve the effects of controlling the projection angle of a lamp source, and improving an overall vivid variation. In addition, an anion layer is coated onto or an anion generator is installed to the elements of the present invention, such that when an electric power is connected, anions are distributed in the air to achieve the effects of purifying the environment and taking care of our health concurrently.

### BRIEF DESCRIPTION OF THE DRAWINGS

FIG. 1 is a perspective view of a decorative lamp of the present invention;

FIG. 2 is an exploded view of a decorative lamp in accordance with a first preferred embodiment of the present invention;

FIG. 3 is a cross-sectional view of a decorative lamp in accordance with a first preferred embodiment of the present invention;

FIG. 4 is a cross-sectional view of a portion of a decorative lamp in accordance with a first preferred embodiment of the present invention;

FIG. 5 is a cross-sectional view of another portion of a decorative lamp in accordance with a first preferred embodiment of the present invention;

FIG. 6 is an exploded view of a decorative lamp in accordance with a second preferred embodiment of the present invention;

FIG. 7 is a cross-sectional view of a decorative lamp in accordance with a second preferred embodiment of the present invention;

FIG. 8 is a cross-sectional view of a portion of a decorative lamp in accordance with a second preferred embodiment of the present invention;

FIG. 9 is a cross-sectional view of another portion of a decorative lamp in accordance with a second preferred embodiment of the present invention;

FIG. 10 is a schematic view of a decorative lamp in accordance with a third preferred embodiment of the present invention; and

FIG. 11 is another schematic view of a decorative lamp in accordance with a third preferred embodiment of the present invention.

### DETAILED DESCRIPTION OF THE PREFERRED EMBODIMENTS

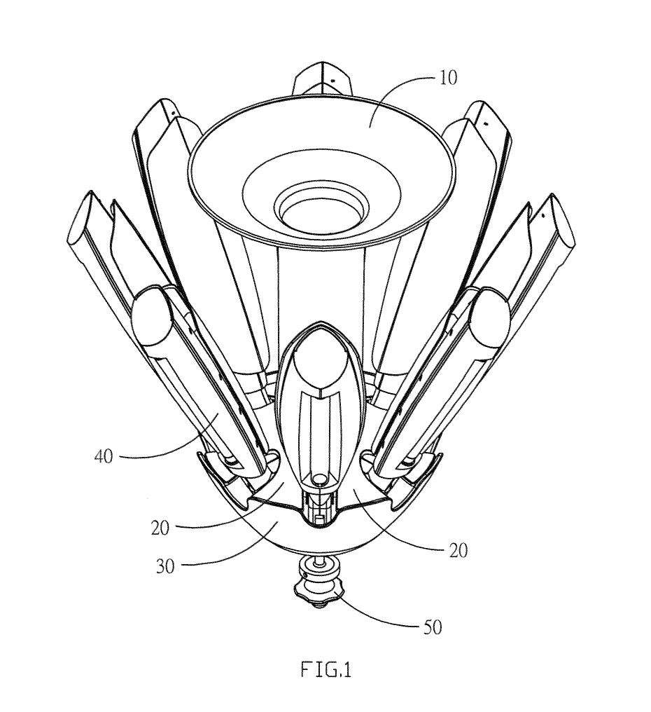

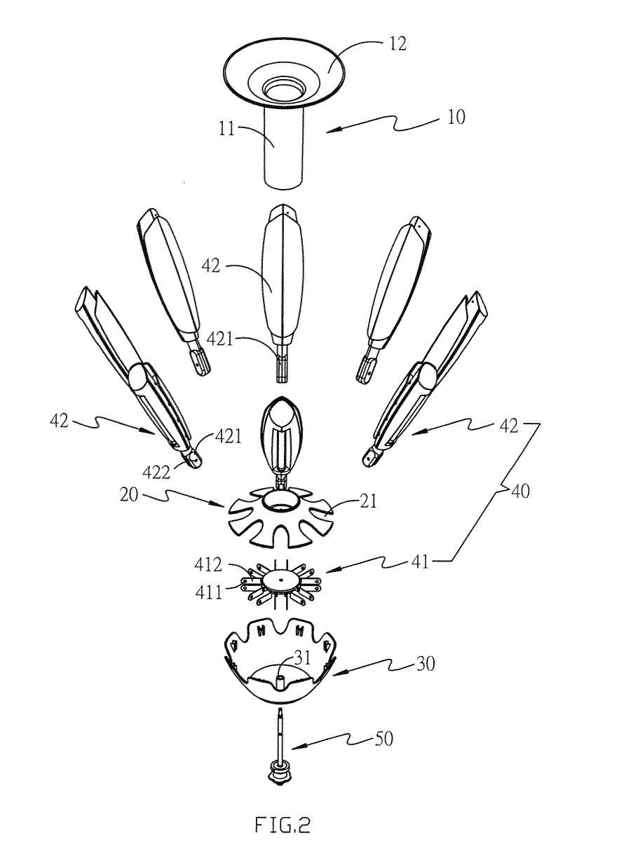

With reference to FIGS. 1 and 2 for a decorative lamp of the present invention, the decorative lamp comprises a top base 10 with a joint as an end and a connecting end as another end, and the connecting end is a connecting rod 11 connected to a cover 20, and the cover 20 includes a plurality of first slots 21 disposed at the external periphery of the cover 20, and the cover 20 is installed onto a supporting decorative base 30, and a connecting device 40 is installed between the cover 20 and the supporting decorative base 30, and the connecting device 40 is composed of a fixing ring element 41 and a plurality of lamp bases 42, and each lamp base 42 includes an extending element 421 connected to the fixing ring element 41. In addition, the supporting decorative base 30 is passed by an adjusting element 50, and the adjusting element 50 is fixed to the fixing ring element 41.

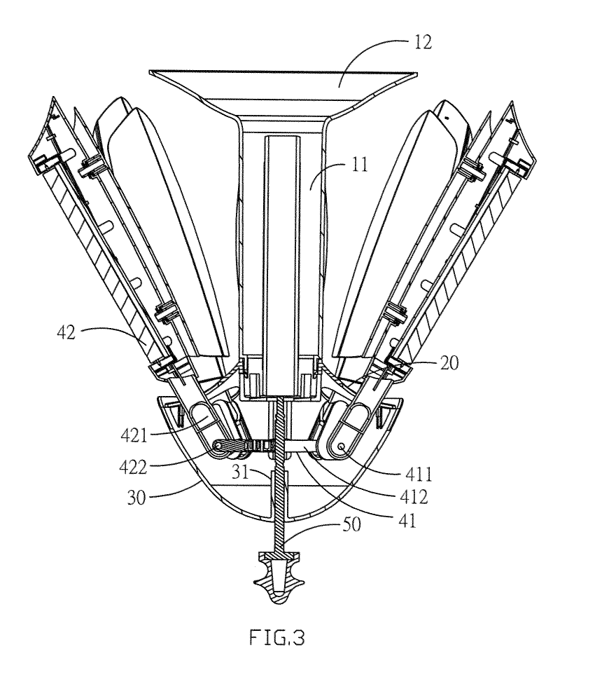

With reference to FIG. 3 for a decorative lamp in accordance with a first preferred embodiment of the present invention, the connecting device 40 is connected to a lamp base 42 by a fixing ring element 41, and the lamp base 42 can be moved pivotally, and the adjusting element 50 can be moved up and down to drive the fixing ring element 41 to control the lamp base 42 to be spread open or closed.

The joint of the top base 10 can be a top portion 12, and the top portion 12 can be fixed by a screw or attached, and the top base 10 can be a hollow body having a stabilizer installed therein, and the connecting rod 11 is connected to the cover 20, and the bottom of the cover 20 is connected to the supporting decorative base 30 by a hook, a latch or a screw.

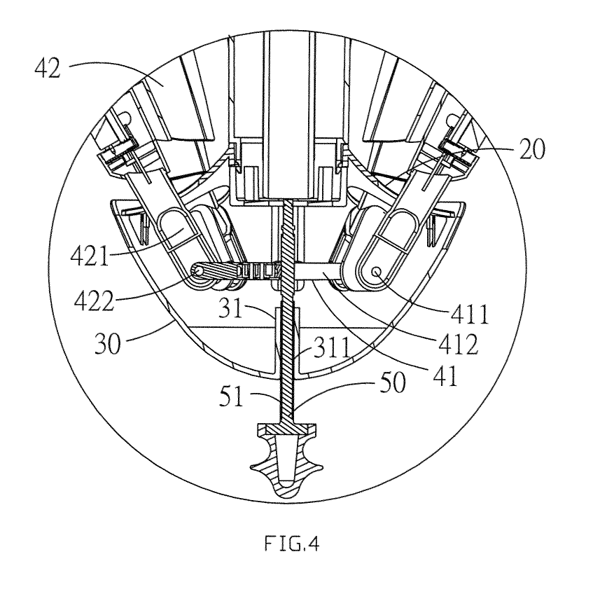

With reference to FIG. 4 for the connection relations between the fixing ring element and the lamp base as follows:

Method 1: The fixing ring element 41 includes a plurality of support frames 412, each having a through hole 411, and two support frames 412 are grouped as a set and installed separately on both sides of the extending element 421 of the lamp base 42, and the tenon hole 422 of the extending element 421 is installed axially with the through hole 411, and the lamp base 42 is rotated by using the tenon hole 422 as an axial center.

Method 2: The fixing ring element 41 includes a plurality of support frames 412, each having a through hole 411 disposed at a position opposite to the first slot 21, and the support frame 412 is installed on a side of the extending element 421, and the through hole 411 and the tenon hole 422 are connected axially with a one-way spring, and the lamp base 42 is rotated by using the tenon hole 422 as the axial center.

The lamp base 42 can be spread open and closed by the following mechanical methods:

Method 1: The adjusting element 50 includes an external thread 51 at an end of the adjusting element, and the supporting decorative base 30 includes a control element 31 having a penetrating internal thread 311, and the adjusting element 50 is locked with the supporting decorative base 30, such that when the adjusting element 50 is rotated, the control element is moved up and down to drive the fixing ring element 41 to control the lamp base 42 to be closed and spread open.

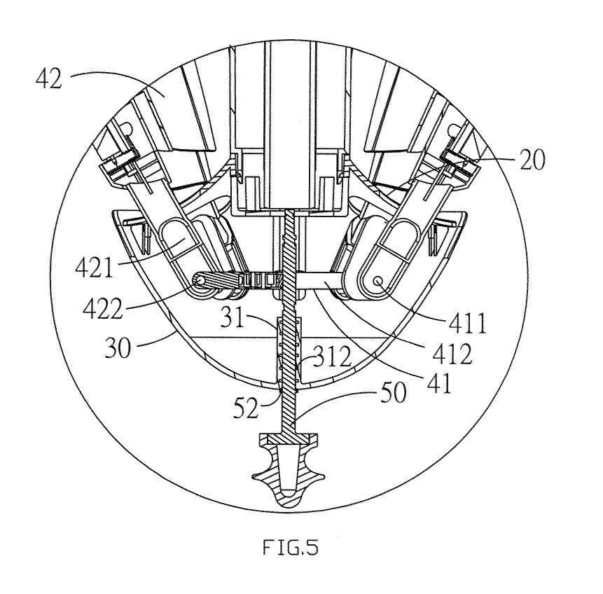

Method 2: The adjusting element 50 includes a protruded ring 52 as shown in FIG. 5, and the supporting decorative base 30 includes a control element 31 having a long penetrating long, and the control element 31 includes a plurality of circular grooves 312, and the adjusting element 50 and the supporting decorative base 30 are latched, such that when the adjusting element 50 is pulled up and down, the protruded ring 52 is latched at the position of the circular groove 312 to drive the fixing ring element 41 to control the lamp base 42 to be closed and spread open.

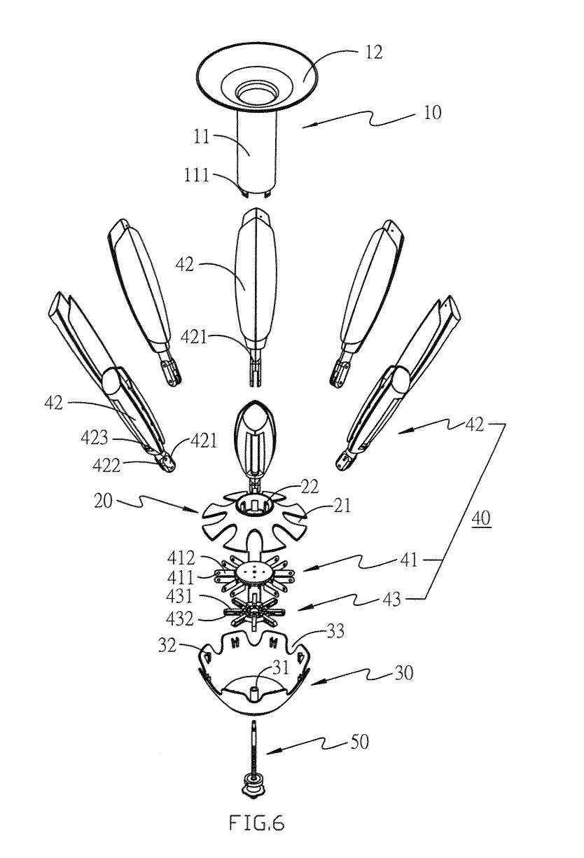

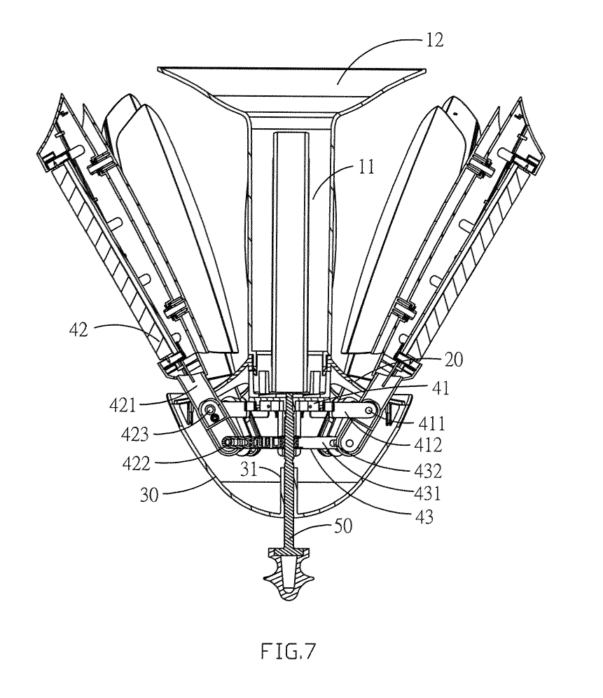

With reference to FIG. 6 for a decorative lamp in accordance with a second preferred embodiment of the present invention, the decorative lamp includes a top base 10 which is a hollow body, and composed of a top portion 12 and a cylindrical connecting rod 11, and the connecting rod 11 includes a hook 111 connected with a protruded rib 22 of a one-way open groove of the cover 20, and the cover 20 has a penetrating hole and a plurality of first slots 21 disposed at an external periphery of the cover 20, while the cover 20 is locked with a latch member 32 of the supporting decorative base 30, and the supporting decorative base 30 includes a second slot 33 disposed opposite to the first slot 21. In addition, a connecting device 40 is installed between the cover 20 and the supporting decorative base 30, and the connecting device 40 is composed of a fixing ring element 41, a pivoting element 43 and a plurality of lamp bases 42, and the lamp base 42 includes an extending element and an adjusting element 50 is passed through the supporting decorative base 30 and fixed to the fixing ring element 41. With reference to FIG. 7 for a decorative lamp in accordance with a second preferred embodiment of the present invention, the connecting device 40 is connected to a lamp base 42 by a fixing ring element 41 and a pivoting element 43, such that the lamp base 42 can be moved pivotally, and the adjusting element 50 is moved up and down to drive the fixing ring element 41 to control the lamp base 42 to be spread open.

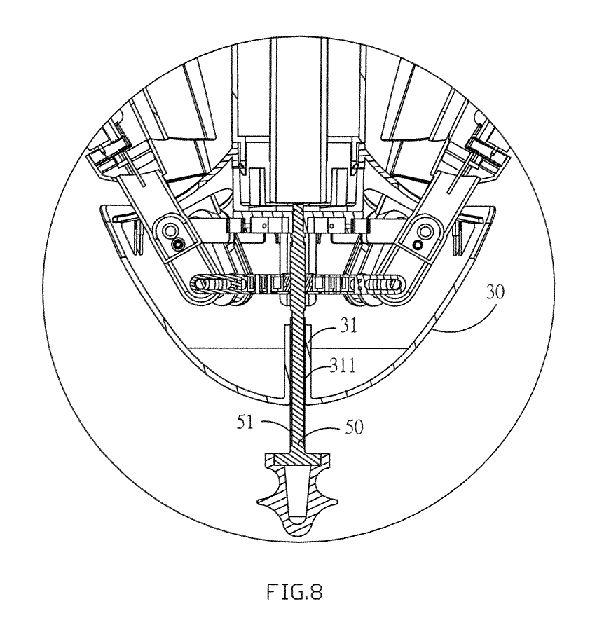

With reference to FIG. 8 for the connection relations among the fixing ring element, the pivoting element and the lamp base, they are connected by the following methods:

Method 1: The fixing ring element 41 includes a plurality of support frames 412, each having a through hole 411, and two support frames 412 are grouped as a set and installed at a protrusion 423 which is situated separately on both sides of the extending element 421 of the lamp base 42, and the through hole 411 is latched with the protrusion 423 to fix a lamp set 42, and the tenon hole 422 of the open accommodating groove of the extending element 412 is connected axially with a slide slot 432 of the pivotal support frame 431 of the pivoting element 43, and the lamp base 42 is rotated by using the tenon hole 422 as the axial center.

Method 2: The fixing ring element 41 includes a plurality of support frames 412 each having a through hole 411, and two support frame 412 are grouped as a set, and installed at a protrusion 423 which is separately situated on both sides of the extending element 421 of the lamp base 42, and the through hole 411 is latched with the protrusion 423 to fix the lamp base 42. In addition, the penetrating tenon hole 422 of the extending element 421 and the slide slot 432 of the pivotal support frame 431 of the pivoting element 43 are installed axially with a one-way spring, and the lamp base 42 slides back and forth in the slide slot 432, and the lamp base 42 is rotated by using the tenon hole 422 as the axial center.

The lamp base 42 can be spread open and closed by the following mechanical methods:

Method 1: The adjusting element 50 has an external thread 51 at an end of the adjusting element 50, and the supporting decorative base 30 includes a control element 31 having a penetrating internal thread 311, and the adjusting element 50 is locked with the supporting decorative base 30, such that when the adjusting element 50 is rotated, the control element 31 is moved up and down to drive the fixing ring element 41 and the pivoting element 43 to control the lamp base 42 to be closed and spread open.

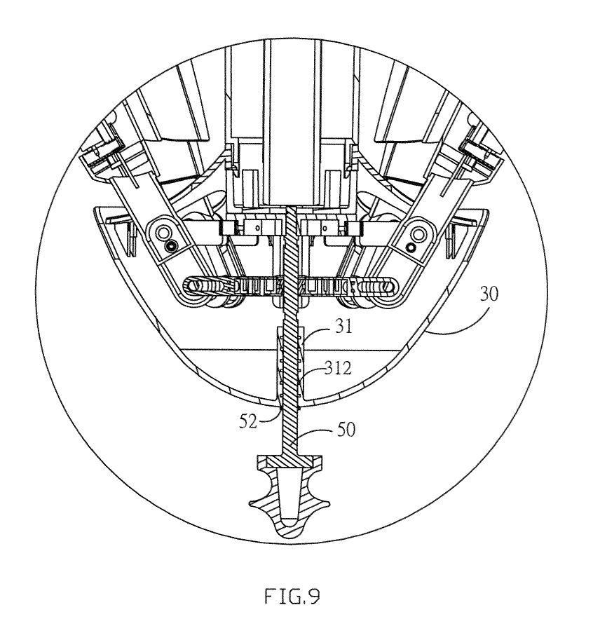

Method 2: The adjusting element 50 as shown in FIG. 9 includes a protruded ring 52, and the supporting decorative base 30 includes a control element 31 having a long penetrating hole, and the control element 31 includes a plurality of circular grooves 312, and the adjusting element 50 is latched with the supporting decorative base 30, such that when the adjusting element 50 is pulled up and down, the protruded ring 52 is latched at the position of the circular groove 312 to drive the fixing ring element 41 and the pivoting element 43 to control the lamp base 42 to be closed and spread open.

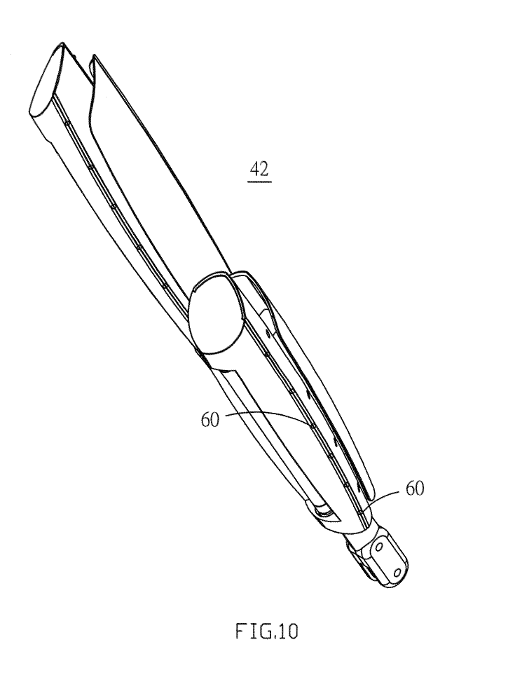

With reference to FIG. 10 for a decorative lamp in accordance with a third preferred embodiment of the present invention, the lamp base is a lamp source, which can be a general lamp or an LED lamp, and the periphery of the lamp base has a plurality of light emitting diodes 60 used for an illumination at nighttime, and the light emitting diode can be a white light, blue light, yellow light or red light for improving the aesthetic atmosphere of the present invention.

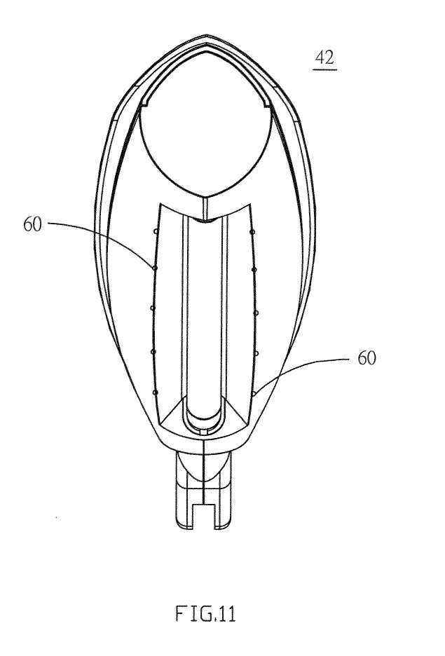

With reference to FIG. 11 for a decorative lamp in accordance with a fourth preferred embodiment of the present invention, the lamp base is a lamp source, and the lamp source can be a general lamp or an LED lamp, and the periphery of the lamp base has a plurality of light emitting diodes 60 used for an illumination at nighttime, and the light emitting diode can be a white light, blue light, yellow light or red light for improving the aesthetic atmosphere of the present invention.

The top base can be a hollow body, and the hollow body includes a stabilizer installed therein.

In the present invention, the top base, the cover, the supporting decorative base, the connecting device and the adjusting element are coated with an anion layer or installed with an anion generator, such that when an electric power is connected, anions are distributed in the air to achieve the effects of purifying the environment and taking care of our health concurrently.

The present invention improves over the prior art and complies with the patent application requirements, and thus is duly filed for patent applications. While the invention has been described by means of specific embodiments, numerous modifications and variations could be made thereto by those skilled in the art without departing from the scope and spirit of the invention set forth in the claims.

I claim,

1. A decorative lamp, comprising:
a top base, with a joint as an end of the top base, and a connecting end as another end of the top base, and the connecting end being a connecting rod;
a cover, coupled to the connecting rod, and having a plurality of first slots formed at an external periphery of the cover;
a supporting decorative base, for installing the cover;
a connecting device, composed of a fixing ring element and a plurality of lamp bases, and each lamp base having an extending element installed axially with the fixing ring element, and the connecting device being installed between the cover and the supporting decorative base; and
an adjusting element, for passing the supporting decorative base, and fixing the fixing ring element.

2. The decorative lamp of claim 1, wherein the fixing ring element includes a plurality of support frames, each having a through hole, and two support frames are grouped as a set.

3. The decorative lamp of claim 1, wherein the extending element includes a tenon hole, and a support frame installed separately on both sides of the extending element, and the through hole and the tenon hole are installed by a fixing element for movably spreading open or closing a lamp set.

4. The decorative lamp of claim 1, wherein the fixing ring element includes a plurality of support frames, each having a through hole corresponding to the position of the first slot.

5. The decorative lamp of claim 1, wherein the extending element includes a tenon hole, a support frame installed onto a side of the extending element, and the through hole and the tenon hole are installed with a fixing element and a one-way spring for rotating a lamp set to be spread open and closed.

6. The decorative lamp of claim 1, wherein the adjusting element has an external thread disposed at an end of the adjusting element, and the supporting decorative base includes a control element having a penetrating internal thread, and the adjusting element is locked to the supporting decorative base, and the adjusting element is moved up and down to lock the control element and drive the fixing ring element to control the lamp base to be closed and spread open.

7. The decorative lamp of claim 1, wherein the adjusting element includes a protruded ring, and the supporting decorative base includes a control element having a long penetrating hole, and the control element includes a plurality of circular grooves, and the adjusting element and the supporting decorative base are latched, and the adjusting element is pulled up and down to adjust the protruded ring to be latched at a position of a circular groove to drive the fixing ring element to control the lamp base to be closed and spread open.

8. The decorative lamp of claim 1, wherein the top base, the cover, the supporting decorative base, the connecting device and the adjusting element are separately coated with an anion layer or installed with an anion generator.

9. A decorative lamp, comprising:
a top base, being a hollow body, and composed of a top portion, and a cylindrical connecting rod;
a cover, coupled to the connecting rod, and having a penetrating hole, and a plurality of first slots formed on an internal wall of the cover;
a supporting decorative base, for installing the cover, and having a second slot disposed opposite to the first slot;
a connecting device, composed of a fixing ring element, a pivoting element and a plurality of lamp bases, each lamp base having an extending element, and the extending element, the fixing ring element and the pivoting element being axially installed, and the connecting device being installed between the cover and the supporting decorative base; and
an adjusting element, passed and installed to the supporting decorative base, and fixed to the fixing ring element and the pivoting element simultaneously.

10. The decorative lamp of claim 9, wherein the connecting rod includes a plurality of hooks

11. The decorative lamp of claim 9, wherein the cover includes a plurality of protruded ribs, each having a one-way open groove, and the protruded rib is latched to fix the connecting rod by the hook.

12. The decorative lamp of claim 9, wherein the supporting decorative base includes a plurality of latch members for securing the cover.

13. The decorative lamp of claim 9, wherein the fixing ring element includes a plurality of support frames, each having a through hole, and two support frames are grouped as a set.

14. The decorative lamp of claim 9, wherein the extending element includes a protrusion disposed separately on both sides of the extending element, and a support frame disposed separately on both sides of the extending element, and the protrusion is latched into the through hole of the support frame to fix the lamp set.

15. The decorative lamp of claim 9, wherein the pivoting element includes a plurality of pivotal support frames, each having a slide slot.

16. The decorative lamp of claim 9, wherein the extending element includes a tenon hole having an open containing groove, and the extending element is coupled to the pivotal support frame, and the tenon hole and the slide slot are used for installing the fixing element, such that the lamp set can slide in the slide slot.

17. The decorative lamp of claim 9, wherein the extending element includes a penetrating tenon hole, and the extending element is coupled to the pivotal support frame, such that the tenon hole and the slide slot are installed with the fixing element and a one-way spring for rotating the lamp set to be spread open.

18. The decorative lamp of claim 9, wherein the adjusting element has an external thread disposed at an end of the adjusting element, and the supporting decorative base includes a control element having a penetrating internal thread, and the adjusting element is locked to the supporting decorative base, and the adjusting element is moved up and down to lock the control element and drive the fixing ring element to control the lamp base to be closed and spread open.

19. The decorative lamp of claim 9, wherein the adjusting element includes a protruded ring, and the supporting decorative base includes a control element having a long penetrating hole, and the control element includes a plurality of circular grooves, and the adjusting element and the supporting decorative base are latched, and the adjusting element is pulled up and down to adjust the protruded ring to be latched at a position of a circular groove to drive the fixing ring element to control the lamp base to be closed and spread open.

20. The decorative lamp of claim 9, wherein the top base, the cover, the supporting decorative base, the connecting device and the adjusting element are separately coated with an anion layer or separately installed with an anion generator.
